(19) United States
(12) Patent Application Publication
(10) Pub. No.: US 2006/0218619 A1
(43) Pub. Date: Sep. 28, 2006

(54) Block artifacts detection

(75) Inventors: Ardjan Dommisse, Eindhoven (NL); Paul Michiel Hofman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., Eindhoven (NL)

(21) Appl. No.: 10/567,218

(22) PCT Filed: Jul. 29, 2004
(86) PCT No.: PCT/IB04/51322

§ 371 Date: Feb. 3, 2006

(30) Foreign Application Priority Data
Aug. 6, 2003 (EP) 031024524

(51) Int. Cl. H04N 7/16

(52) U.S. Cl. 725/148

(57) ABSTRACT

A block artifacts detection device (100) for detecting block artifacts in a video signal is disclosed. The block artifacts detection device (100) comprises: computing means (102) for computing a gradient signal on basis of the video signal; establishing means (104) for establishing a list of samples corresponding to respective local maximum values of the gradient signal; a histogram determining means (106) for determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and analyzing means (108) for analyzing the histogram of inter-sample distances and for producing a block artifact indicator on basis of the histogram.

The invention relates to a block artifacts detection device for detecting block artifacts in a video signal.

The invention further relates to an image processing apparatus comprising:
receiving means for receiving a video signal corresponding to a sequence of input images;
such a block artifacts detection device; and
an image processing unit for calculating a sequence of output images on basis of the sequence of input images, the image processing unit being controlled by the block artifacts detection device.

The invention further relates to a method of detecting block artifacts in a video signal.

The invention further relates to a computer program product to be loaded by a computer arrangement, comprising instructions to detect block artifacts in a video signal, the computer arrangement comprising processing means and a memory.

The appearance of so-called blocking artifacts or block artifacts in video frames, caused by digital block-based encoding schemes, e.g. MPEG2, or H.264, has become an increasing problem in the field of video processing. Especially on high-quality display devices, the perceived image quality can be degraded substantially by these artifacts. To make matters worse, image enhancement units, not only enhance edges of the source material, but can also boost these block-edge artifacts, deteriorating the image quality even further.

The block artifacts are introduced in the transmission chain before reception by a consumer device, e.g. a television. The appearance of block artifacts is caused by an imperfect and lossy compression scheme, which processes individual blocks of pixels independently. These digital coding artifacts can appear, for example, in a lossy compression before satellite transmission, after which the video signal may be further broadcasted by analog means. In such a typical case, information on the position and size of the blocks or any other parameter from the digital compression is not directly available in the analog video signal. In order to assess the presence and visibility of block artifacts, a device and a method is required to extract this information from the video signal: to locate the artifacts and measure their visibility.

Block artifact indicators represent this type of information. Block artifact indicators can be applied to control further image processing. For example to control (or turn off) a sharpening unit in the case of encountering a video signal with relatively many block artifacts. Alternatively processing, e.g. smoothing can be applied to reduce these block artifacts.

An embodiment of the method of the kind described in the opening paragraph is known from WO 01/20912. The known method comprises a step of filtering the input signal with a gradient filter to provide a filtered signal and a step of calculating a block level metric, i.e. a block artifact indicator, for processing the filtered signal to identify and count blocking artifacts as a function of their position in a grid. The known method works appropriately for a limited set of predetermined block grid sizes. Unfortunately, the actual spatial size of the block artifacts in the received video signal often differs from the sizes of the limited set of predetermined block grid sizes because of spatial scaling of the image data being represented by the video signal, somewhere in the chain from transmission to reception.

It is an object of the invention to provide a block artifacts detection device of the kind described in the opening paragraph which is relatively robust.

This object of the invention is achieved in that the block artifacts detection device comprises:
computing means for computing a gradient signal on basis of the video signal;
establishing means for establishing a list of samples corresponding to respective local maximum values of the gradient signal;
histogram determining means for determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing means for analyzing the histogram of inter-sample distances and for producing a block artifact indicator on basis of the histogram.

An important aspect of the invention is that a histogram of inter-sample distances is made on basis of all distances between samples of the group of samples corresponding to respective local maximum values of the gradient signal, within a sliding window. That means all distance between samples within a moving aperture located on a portion of the list of samples. Hence, not only the distances between adjacent samples are taken into account but all mutual distances between samples in a spatial neighborhood. Besides that, there is no a priori distance applied, i.e. a predetermined number of pixels distance considered, while establishing the histogram. That means that not only distances between samples of e.g. 8 pixels are counted but all distances between samples within the extent of the aperture, expressed in an integer number of pixels. By means of appropriate analyzing the histogram comprising the information of all distances, the block artifact indicator is provided. The analyzing comprises the selection of a dominant bin, corresponding to a particular inter-sample distance, from the histogram and optionally combining the value of that bin with values of neighboring bins.

In an embodiment of the block artifacts detection device according to the invention, the block artifact indicator corresponds with a spatial size of the block artifacts, the block artifact indicator being related to a particular inter-sample distance. The spatial size of the block artifacts can relatively easy be determined by directly applying the selected bin, i.e. inter-sample distance. Preferably the block artifact indicator is computed on basis of the value of that bin with values of neighboring bins. This allows to compute the spatial size of the block artifacts with sub-pixel accuracy. Because of spatial scaling of the video data, the block size might e.g. be 10 ⅔pixel.

In an embodiment of the block artifacts detection device according to the invention, the block artifact indicator corresponds with a measure of visibility of the block artifacts, the block artifact indicator being related to a frequency of occurrence of a particular inter-sample distance. It has been proven that the frequency of occurrence or the relative frequency of occurrence of the particular inter-sample distance is a good indicator for the visibility of the block artifacts. Optionally, also the values of two neighboring bins of the selected bin are taken into for the computation of the block artifact indicator corresponding with a measure of visibility of the block artifacts.

In an embodiment of the block artifacts detection device according to the invention, the histogram of inter-sample distances is a weighted histogram. That means that the distances are not just counted but that the contribution of each of the distances to the histogram is based on a respective weight. For example, the weighting of the first distance is based on the local maximum value of the first one of the samples. Optionally the weighting of the first distance is also based on the local maximum value of the second one of the samples. Preferably, the weighting of the first distance is based on a portion of the gradient signal comprising a sub-portion corresponding to the first one of the samples. In other words, also values of the gradient signal around the local maximum value are taken into account for the weighting. An advantage of applying a weighted histogram is that the noise robustness is further increased.

In an embodiment of the block artifacts detection device according to the invention, the gradient signal is computed on basis of a first intermediate signal being computed by summation of respective pixel values of a number of video lines of the video signal. This summation is a kind of low-pass filtering. An advantage of this embodiment is that the noise robustness is further increased.

In an embodiment of the block artifacts detection device according to the invention, the gradient signal is computed by high-pass filtering of a first intermediate signal which is based on computing absolute differences between subsequent pixel values of the video signal. This high-pass filtering enables to apply a robust thresholding in order to create the list of relevant local maximum values. That means that non-relevant local maximum values, having a value below a predetermined threshold are disregarded.

It is a further object of the invention to provide an image processing apparatus, of the kind described in the opening paragraph, comprising a block artifacts detection device which is relatively robust.

This object of the invention is achieved in that the block artifacts detection device comprises:
computing means for computing a gradient signal on basis of the video signal;
establishing means for establishing a list of samples corresponding to respective local maximum values of the gradient signal;
histogram determining means for determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing means for analyzing the histogram of inter-sample distances and for producing a block artifact indicator on basis of the histogram.

The image processing apparatus may comprise additional components, e.g. a display device for displaying the output images. The image processing unit might support one or more of the following types of image processing:
Video compression, i.e. encoding or decoding, e.g. according to the MPEG standard.
De-interlacing: Interlacing is the common video broadcast procedure for transmitting the odd or even numbered image lines alternately. De-interlacing attempts to restore the full vertical resolution, i.e. make odd and even lines available simultaneously for each image;
Image rate conversion: From a series of original input images a larger series of output images is calculated. Output images are temporally located between two original input images; and
Temporal noise reduction. This can also involve spatial processing, resulting in spatial-temporal noise reduction.

The image processing apparatus might e.g. be a TV, a set top box, a VCR (Video Cassette Recorder) player, a satellite tuner, a DVD (Digital Versatile Disk) player or recorder.

It is a further object of the invention to provide a method, of the kind described in the opening paragraph which is relatively robust.

This object of the invention is achieved in that the method comprises:
computing a gradient signal on basis of the video signal;
establishing a list of samples corresponding to respective local maximum values of the gradient signal;
determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing the histogram of inter-sample distances and producing a block artifact indicator on basis of the histogram.

It is a further object of the invention to provide a computer program product, of the kind described in the opening paragraph which is relatively robust.

This object of the invention is achieved in that the computer program product, after being loaded, providing said processing means with the capability to carry out:
computing a gradient signal on basis of the video signal;
establishing a list of samples corresponding to respective local maximum values of the gradient signal;
determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing the histogram of inter-sample distances and producing a block artifact indicator on basis of the histogram.

Modifications of the block artifacts detection device and variations thereof may correspond to modifications and variations thereof of the image processing apparatus, the method and the computer program product, being described.

These and other aspects of the block artifacts detection device, of the image processing apparatus, of the method and of the computer program product, according to the invention will become apparent from and will be elucidated with respect to the implementations and embodiments described hereinafter and with reference to the accompanying drawings, wherein:

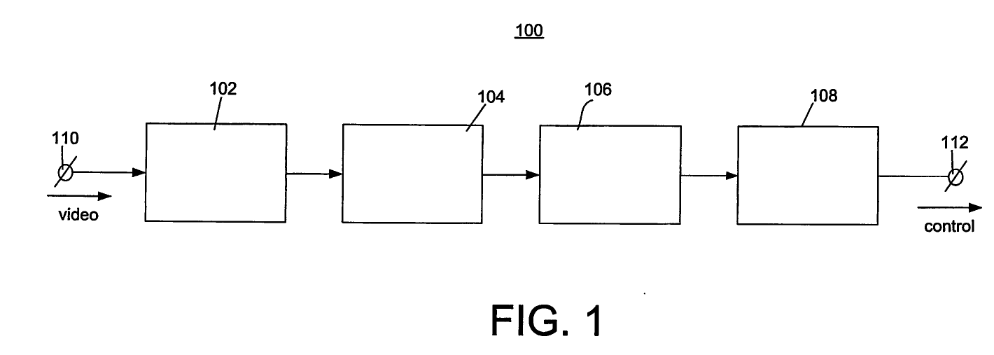

FIG. 1 schematically shows an embodiment of the block artifacts detection device;

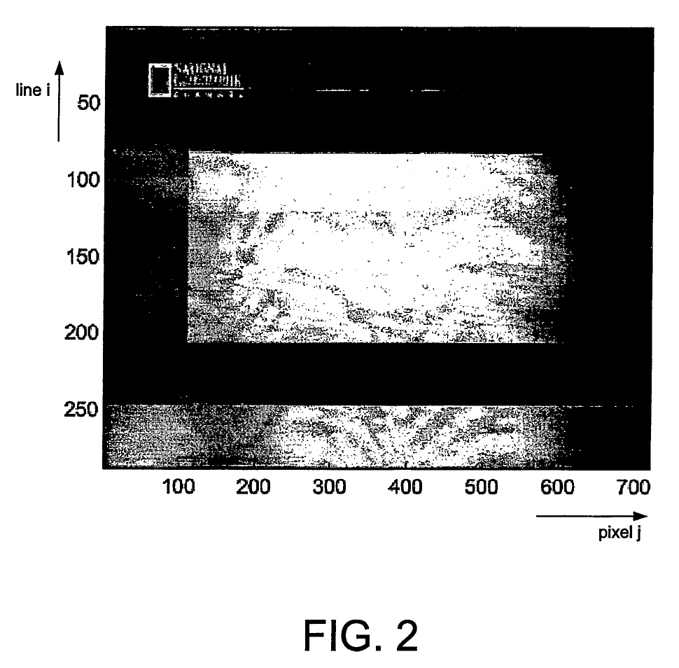

FIG. 2 shows an input image;

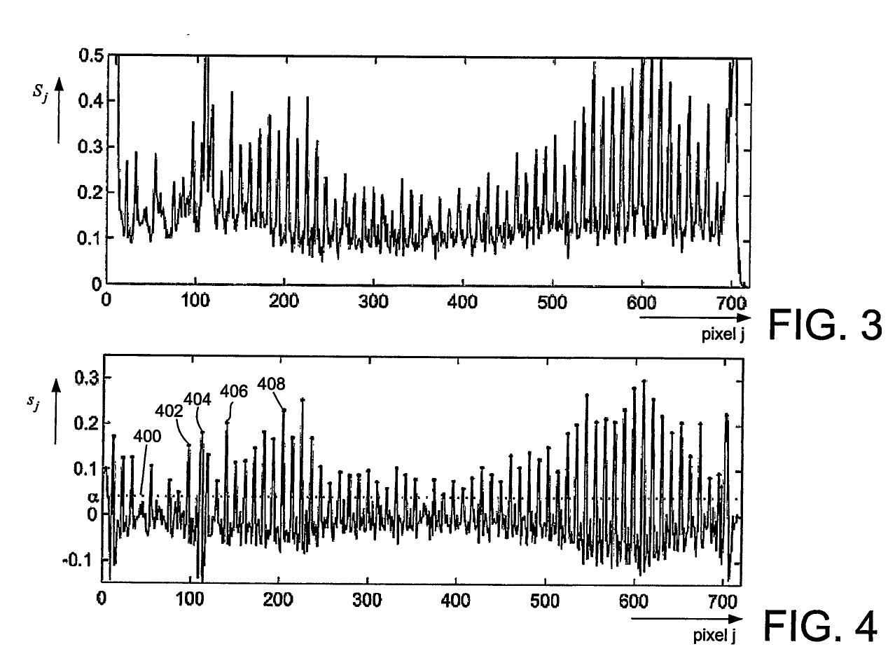

FIG. 3 shows an example of a gradient signal \vec{S}, based on the image of FIG. 2;

FIG. 4 shows the detrended gradient signal \vec{s} based on the gradient signal \vec{S} of FIG. 3;

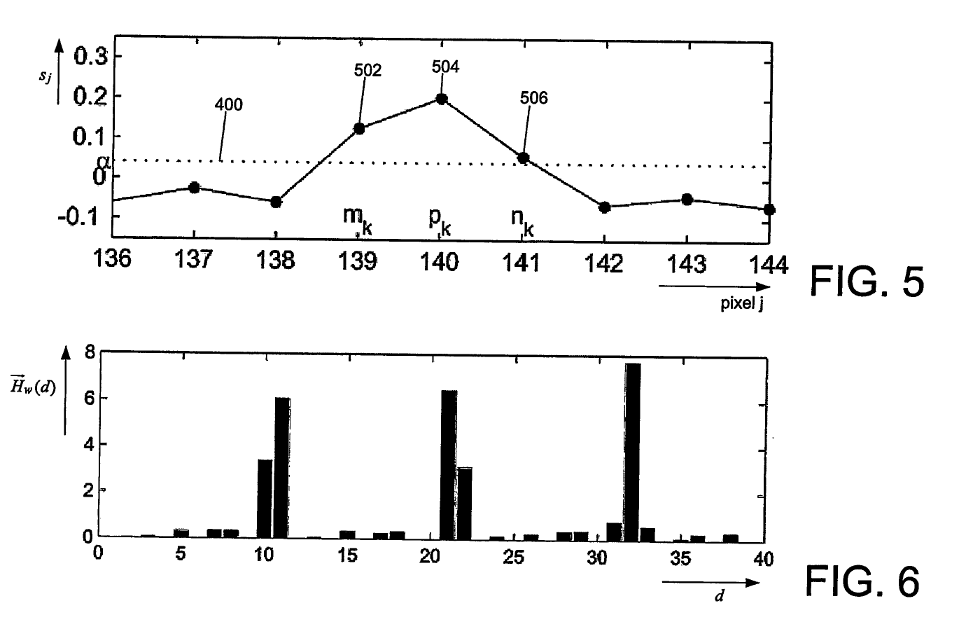

FIG. 5 shows a portion of the detrended gradient signal \vec{s} as shown in FIG. 4;

FIG. 6 shows a weighted inter-peak distance histogram \vec{H}_{w};

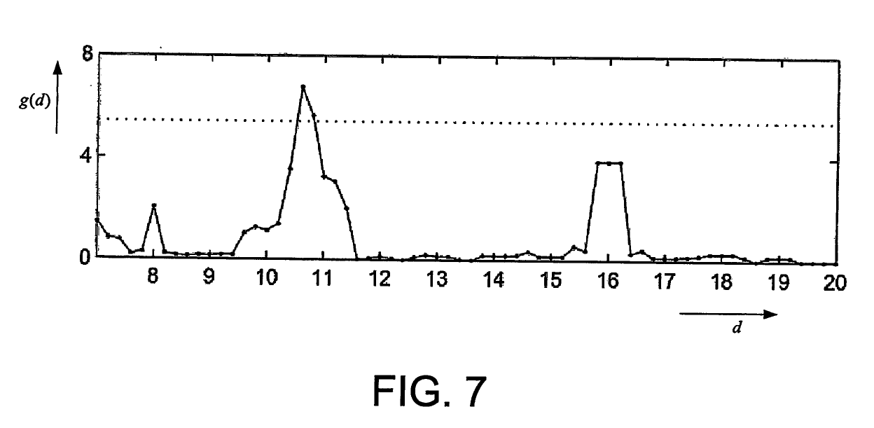

FIG. 7 shows an example of g(d); and

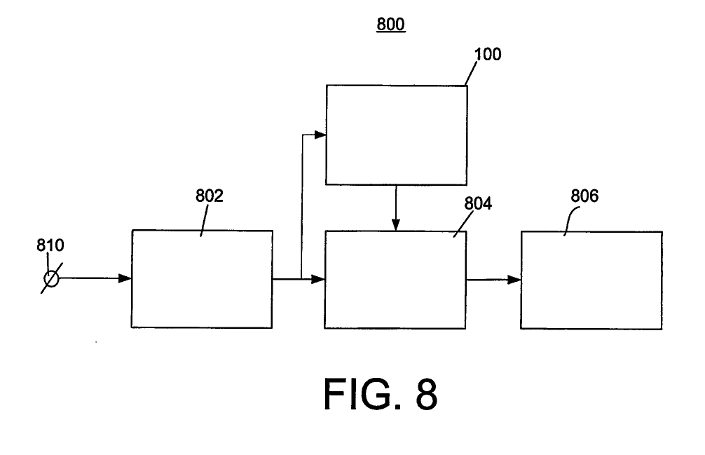

FIG. 8 schematically shows an embodiment of the image processing apparatus 400 according to the invention.

Same reference numerals are used to denote similar parts throughout the Figures.

FIG. 1 schematically shows an embodiment of the block artifacts detection device 100 according to the invention. The block artifacts detection device 100 is provided with a video signal at the input connector 110 and is arranged to provide a control signal representing the detected block artifacts, at its output connector 112. The control signal is related to the detected block artifacts. The block artifacts detection device 100 comprises:
a computing unit 102 for computing a gradient signal \vec{S} on basis of the video signal;
a maximum detecting unit 104 for establishing a list of samples corresponding to respective local maximum values 402-408 of the gradient signal;
a histogram determining unit 106 for determining a histogram of inter-sample distances, a first one of the inter-sample distances corresponding to a first distance between a first one of the samples and a second one of the samples succeeding the first one of the samples; and
an analyzing unit 108 for analyzing the histogram of inter-sample distances and for producing a block artifact indicator on basis of the histogram.

Preferably, the histogram determining unit 106 is arranged to create a weighted histogram as described in connection with FIG. 5. This measure can be seen as a separate invention. Preferably all inter-sample distances within a sliding window are determined. The working of the block artifacts detection device 100 is described in connection with the FIGS. 2-7.

The computing unit 102, the maximum detecting unit 104, the histogram determining unit 106 and the analyzing unit 108 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 2 shows an input image, in particular a luminance field being grabbed from the National Geographic Channel. Note the appearance of regular blocks as a result of a high compression ratio. In this example, block artifacts appear with a period of 10 ⅔ pixel. The image format is Standard Definition (SD): 288 lines of each 720 pixels. Below will be explained how the block artifact indicators are computed. This is based on detection of vertical edges. An analogous approach then holds for horizontal edges.

Define an M×N image \vec{I} with elements Iᵢⱼ where i and j are integer grid positions. A first step is the computation of a gradient signal. This comprises the computation of the absolute horizontal gradient vector \vec{D} of which the elements are specified by Equation 1:
Dᵢⱼ =|I_{i+l,j}−Iᵢⱼ| (1)

Next, all relevant transitions are counted or, in other words, any pixels that are located on an edge. Thus, the occurrences are counted, along y-direction, that the absolute gradient exceeds a first predetermined threshold θ. A typical value of θequals 2 with the values of \vec{I} ranging form 0-255. This yields a vector \vec{S} with elements Sⱼ:

$${S}_{j} = \frac{1}{M} {\sum }_{t = 1}^{M} T ( {D}_{ij} - θ ) \qquad ( 2 )$$

where j=1, 2, . . . , N and T(x) is a step-function as specified in Equation 3:

$$T ( x ) = \{ \begin{matrix}1 & x > 0 \\ 0 & x \leq 0\end{matrix} \qquad ( 3 )$$

An example of \vec{S}, based on the image of FIG. 2 is shown in FIG. 3.

In the case that image \vec{I} does contain notable MPEG block artifacts, it is expected that \vec{S} is a signal that contains peaks, i.e. local maximum values, at regular intervals. The next step is to detect the repetition period of these peaks. It was found that Equation 2 provides a multi-peak signal that is more robust to the influence of original image edges, i.e. not the MPEG block artifacts, than just a row-sum of absolute gradient \vec{D}. This can be understood from the notion that a large gradient is simply counted, just as a relatively small gradient. This reduces the relative contribution of a relatively large gradient to the average S. Typical MPEG block artifacts are not expected to create very large gradients, but are expected to be large enough to be clearly visible. The goal is therefore more to find how often an edge is found on a vertical image column, than to find the average edge size. In the latter case, large edges in the source material could result in dominant peaks in \vec{S}, rather than the more moderate MPEG block edges.

Any significant peak in \vec{S} is considered to be a the result of a suspected block edge, i.e. block artifact. In order to find suspected block edges, a detection of peaks in \vec{S} is required. Before determining which peak exceeds a second predetermined threshold α, and can be considered as a relevant peak, the low frequent trend of \vec{S} is subtracted from \vec{S}. This is effectively a high-pass filtering and is achieved by subtracting from each value Sⱼ the average of its direct 2n+1 size neighborhood, j−n, j−n+1, . . . , j+n. A typical value of n=4. The detrended edge count sⱼ is specified in Equation 4:

$${s}_{j} = {S}_{j} - \frac{1}{2 n + 1} {\sum }_{k = - n}^{+ n} {S}_{j + k} \qquad ( 4 )$$

FIG. 4 shows the detrended edge count \vec{s}based on the edge count signal \vec{S} of FIG. 3. The dotted line 400 corresponds with the second predetermined threshold α. The dots 402-408 indicate detected peaks above the second predetermined threshold α. Detrending \vec{S} effectively comes down to normalizing each Sⱼ, with respect to its direct neighbors or, in other words, comparing the amount of edge found at j with the amount of edge found next to j . This makes sense as one considers that in detailed regions, with detailed textures, on average many edges will be detected. Hence, an edge is taken into account if it is not only high in absolute sense, but also in a relative sense.

A next step is detection of relevant peaks, i.e. local maximum values. Suppose that there are N_{edge} portions of \vec{s} that exceed the second predetermined threshold α. That means that the list of samples corresponding to respective local maximum values of the gradient signal comprises N_{edge} samples. The locations of the begin and end of the k-th peak 504 are defined such that:
if mₖ≦j ≦nₖ then sⱼ≧α, k=1, 2, . . . N_{edge} (5)
The location Pₖ of the k-th peak 504 is the index j for which a local maximum value of \vec{s} occurs:
m_{k≦p}ₖ≦nₖ, sₚₖ≧sₚₖ±1 (6)
This peak detection is illustrated in FIG. 5 for a portion of the detrended edge count \vec{s} as shown in FIG. 4. mₖ 502 is at the first pixel above the second predetermined threshold α as illustrated by means of the dotted line 400 and nₖ 506 is at the last pixel above the second predetermined threshold α. The volume Vₖ of the k-th peak is then defined as:

$${V}_{k} = {\sum }_{j = {m}_{k}}^{{n}_{k}} ( {s}_{j} - α ) \qquad ( 7 )$$

Preferably, this volume Vₖ is used as a weight in the inter-peak histogram, i.e. histogram of inter-sample distances.

In order to determine whether the detrended edge count \vec{s} comprises repetitive peaks, i.e. relevant inter-sample distances, one could start the analysis by computing a histogram of the distances between peaks within a limited vicinity, i.e. window or aperture. The limit of this neighborhood Nₕᵢₛₜ is determined by the maximum expected block size taking into account a scaling factor. A typical value Nₕᵢₛₜ=38 pixels. The inter-peak distance histogram H could be computed by means of the following piece of C-code:

for (k=1; k < Nedge; k++) {
i = 1;
while ( ((d = p[k+i] − p[k]) < Nhist) && (k+i <= Nedge) ) {

H[d] += 1; /* add 1 to histogram */
i += 1;

}

}

In the computation above, \vec{H} does not explicitly take any edge visibility into account: it merely counts the inter-peak distances. Thus it counts repetitive appearing edges, but regardless of the extent of the block edges. Preferably a weighted inter-peak distance histogram \vec{H}_{w} is computed. FIG. 6 shows the weighted inter-peak distance histogram \vec{H}_{w}. Note that the base period, i.e. block artifact grid size is non-integer, 10 ⅔. This can be derived from the fact that the histogram volume is not concentrated in single bins but in pairs of bins, e.g. bin d=10 and d=11,and bin d=21 and d=22.In order to take the edge visibility into account in the histogram H_{w} as a weight, the volume measures Vₖ of the edges, as defined in Equation 7 are used as a weight. In the current method, the distance between two samples is weighted with the volumes of both samples. The weighted inter-peak distance histogram \vec{H}_{w} could be computed by means of the following piece of C-code:

for (k=1; k < Nedge; k++) {

i = 1;
while ( ((d = p[k+i] − p[k]) < Nhist) && (k+i <= Nedge) ) {

H[d] += (V[k] + V[k+i])/2; /* add volumes as weight
to histogram */
i += 1;

}

}

where V[k] corresponds to Vₖ as defined in Equation 7.

Next, in order to determine repetitive peaks, the weighted inter-peak distance histogram \vec{H}_{w} is sampled at integer multiples, k of each possible base period d, thus at k×d:

$$for ( k = 1 ; k < Nedge ; k ++ ) \{ i = 1 ; while ( ( ( d = p [ k + i ] - p [ k ] ) < Nhist ) \&\& ( k + i <= Nedge ) ) \{ H [ d ] += 1 ; {/}^{*} add 1 to {histogram}^{*} / i += 1 ; \} \}$$

If the underlying base period were d, then the histogram would peak at integer multiples, k×d. Therefore, g(d) would attain its maximum for the actual, underlying base period d. The location of a clear, first maximum of g(d) is then taken as an indicator of the underlying base period. It was found that finding the first peak in g(d) lead to a more stable estimate of the underlying base period d, than detection of the first prominent histogram bin H_{d}. The reason is that, in practical cases, it appears that the histogram at 1×d is not always that prominent. For example, suppose that the base period is, in fact, d=8, it appears that, in some cases H₈ is not that prominent, whereas H₁₆ and H₂₄ clearly are. Such a case does not necessarily pose a problem, if a first peak is searched in g(d) rather than H_{d}. See FIG. 7 for an example of g(d). In this FIG. 7 the inter-peak distance d is sampled at 0.2 intervals.

An aspect of the invention is that the block artifacts detection device is arranged to produce a control signal, which indicates the visibility of blocking artifacts, without further need of information on coding parameters used earlier in the processing chain. Processing in television sets and video recording devices e.g. DVD+RW and Hard Disk Recorders can be adapted to these cases where a significant amount of blocking edges are detected. The first block artifact indicator corresponds with a measure of visibility of the block artifacts. The first block artifact indicator is related to a frequency of occurrence of a particular inter-sample distance and preferably equal to the mean of a number of values, including the relative frequency of occurrence of the particular inter-sample distance.

Another aspect of this invention is that the block artifacts detection device is arranged to provide a control signal, which indicates one or more dimensions of the blocking grid without the need for information that is not explicitly present in the analog video signal. This information can also be used by the processing, as it indicates whether a scaling operation has been applied, assuming that the applied coding scheme uses blocks with a width and height of eight pixels. The second block artifact indicator d, corresponding with a spatial size of the block artifacts, is related to a particular inter-sample distance. However, the second block artifact indicator d is not necessarily equal to a particular inter-sample distance, which has an integer value.

FIG. 8 schematically shows an embodiment of the image processing apparatus 400 according to the invention, comprising:
receiving means 802 for receiving a video signal corresponding to a sequence of input images;
a block artifacts detection device 100 for detecting block artifacts in the video signal, as described in connection with FIG. 1;
an image processing unit 804 for calculating a sequence of output images on basis of the sequence of input images, the image processing unit being controlled by the block artifacts detection device; and
a display device 806 for displaying the output images of the image processing unit 804.

The signal may be a broadcast signal received via an antenna or cable but may also be a signal from a storage device like a VCR (Video Cassette Recorder) or Digital Versatile Disk (DVD). The signal is provided at the input connector 810. The image processing apparatus 800 might e.g. be a TV. Alternatively the image processing apparatus 800 does not comprise the optional display device but provides the output images to an apparatus that does comprise a display device 806. Then the image processing apparatus 800 might be e.g. a set top box, a satellite-tuner, a VCR player, a DVD player or recorder. Optionally the image processing apparatus 800 comprises storage means, like a hard-disk or means for storage on removable media, e.g. optical disks. The image processing apparatus 800 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A block artifacts detection device (100) for detecting block artifacts in a video signal, the block artifacts detection device (100) comprising:
computing means (102) for computing a gradient signal on basis of the video signal;
establishing means (104) for establishing a list of samples corresponding to respective local maximum values of the gradient signal;
histogram determining means (106) for determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing means (108) for analyzing the histogram of inter-sample distances and for producing a block artifact indicator on basis of the histogram.

2. A block artifacts detection device (100) as claimed in claim 1, whereby the block artifact indicator corresponds with a spatial size of the block artifacts, the block artifact indicator being related to a particular inter-sample distance.

3. A block artifacts detection device (100) as claimed in claim 1, whereby the block artifact indicator corresponds with a measure of visibility of the block artifacts, the block artifact indicator being related to a frequency of occurrence of a particular inter-sample distance.

4. A block artifacts detection device (100) as claimed in claim 1, whereby the histogram of inter-sample distances is a weighted histogram.

5. A block artifacts detection device (100) as claimed in claim 4, whereby a weighting of the first distance is based on the local maximum value of the first one of the samples.

6. A block artifacts detection device (100) as claimed in claim 5, whereby the weighting of the first distance is based on a portion of the gradient signal comprising a sub-portion corresponding to the first one of the samples.

7. A block artifacts detection device (100) as claimed in claim 1, whereby the gradient signal is computed on basis of a first intermediate signal being computed by summation of respective pixel values of a number of video lines of the video signal.

8. A block artifacts detection device (100) as claimed in claim 1, whereby the gradient signal is computed by high-pass filtering of a first intermediate signal which is based on computing absolute differences between subsequent pixel values of the video signal.

9. An image processing apparatus (800) comprising:
receiving means (802) for receiving a video signal corresponding to a sequence of input images;
a block artifacts detection device (100) for detecting block artifacts in the video signal, as claimed in claim 1; and
an image processing unit (804) for calculating a sequence of output images on basis of the sequence of input images, the image processing unit being controlled by the block artifacts detection device (100).

10. An image processing apparatus (800) as claimed in claim 9, characterized in further comprising a display device (806) for displaying the output images.

11. A method of detecting block artifacts in a video signal, the method comprising:
computing a gradient signal on basis of the video signal;
establishing a list of samples corresponding to respective local maximum values of the gradient signal;
determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing the histogram of inter-sample distances and producing a block artifact indicator on basis of the histogram.

12. A computer program product to be loaded by a computer arrangement, comprising instructions to detect block artifacts in a video signal, the computer arrangement comprising processing means and a memory, the computer program product, after being loaded, providing said processing means with the capability to carry out:
computing a gradient signal on basis of the video signal;
establishing a list of samples corresponding to respective local maximum values of the gradient signal;
determining a histogram of inter-sample distances, a first one of the inter-sample distances corresponding to a first distance between a first one of the samples and a second one of the samples succeeding the first one of the samples, and a second one of the inter-sample distances corresponding to a second distance between the first one of the samples and a third one of the samples succeeding the second one of the samples; and
analyzing the histogram of inter-sample distances and producing a block artifact indicator on basis of the histogram.
